(19) United States
(12) Patent Application Publication
(10) Pub. No.: US 2010/0251156 A1
(43) Pub. Date: Sep. 30, 2010

(54) Facilitating Discovery and Re-Use of Information Constructs

(75) Inventor: Marc Gregory Cantwell, Hove (GB)

Correspondence Address: Snell & Wilmer L.L.P. (AMEX), ONE ARIZONA CENTER, 400 E. VAN BUREN STREET, PHOENIX, AZ, 85004-2202, US

(73) Assignee: American Express Travel Related Services Company, Inc., New York, NY (US)

(21) Appl. No.: 12/415,390

(22) Filed: Mar. 31, 2009

(51) Int. Cl. G06F 3/048

(52) U.S. Cl. 715/771

(57) ABSTRACT

A method, system, and computer program product are used to facilitate discovery and re-use of information constructs. The method includes providing an information construct database including a plurality of information constructs, and providing an access interface allowing a user to access the information construct database. The access interface comprises a discovery interface for allowing the user to identify one or more desired information constructs in the information construct database, a selection interface allowing the user to add the one or more desired information constructs to a list of selected information constructs, an acquisition interface allowing the user to acquire the information constructs added to the list of selected information constructs in one or more desired formats, and a publishing interface allowing the user to add one or more information constructs in an available format to the information construct database.

### FIELD

Embodiments of the present invention generally relate to information modeling and more specifically methods, systems and computer program products to facilitate discovery and re-use of information constructs in information modeling.

### RELATED ART

Information models are used to characterize the properties, relationships, and/or behaviors of people or things. For example, in the financial services industry, an information model may be used to describe the metadata associated with the personal details and financial activities (e.g., spending) of customers. In the manufacturing industry, for example, an information model may describe the characteristics and specifications of different kinds of products. Examples of information models include, but are not limited to: Entity Relationship Diagrams, UML Diagrams and XML Schema Models. Information models typically contain only metadata, and not the data itself.

Various information modeling tools for assembling an information model are known in the art. The information model may be assembled using a plurality of information constructs. An information construct is essentially an object or concept about which properties are collected. An information construct may alternatively be referred to as, for example, an entity, a relational database table, an XML schema complex type, an XML schema group, a Java class, etc. Information constructs representing common business concepts (e.g., Product, Customer) can be found in many distinct information models across an organization. In order to speed the development of new information models and to reduce environmental complexity, it is highly beneficial for users to be able to discover existing information constructs and reuse them in their own models. However, in the currently available information modeling tools, information constructs cannot typically be shared between information models of differing types, nor between information models of the same type but created in a different modeling tool. Further, many information modeling tools do not allow a user to search for or otherwise discover information constructs for reuse from across different information models—even where these are models of the same type and created in the same tool. Instead, the user has to rely on his tacit knowledge to identify such information constructs.

In some information modeling tools that are currently available, the user can search across models for information constructs. However, the reuse process is not always ingrained into these tools and so, to incorporate existing information constructs, the user commonly has to manually copy the information constructs into a target information model. Thus, the process of reuse of the information constructs is very cumbersome and may not capture the lineage of the reused construct.

Additionally, in currently available information modeling tools, typically there is no capability to import individual information constructs, only complete information models. Furthermore, the types of information model that can be imported in this way are limited to certain formats. Therefore, even if the user has access to an information construct that should be reused but is external to their modeling tool, it is generally not possible to reuse the construct by importing the construct into a target information model.

The above mentioned difficulties in reusing already existing information constructs lead to development of new information constructs every time the user wants to assemble a new information model or extend an existing one, thereby incurring additional time and effort. Further, this also results in many information constructs that are similar but not identical and are difficult to maintain.

Therefore, there is a need for a method, system and computer program product for enabling the user to discover and re-use an information construct across different information models and different modeling environments.

### BRIEF SUMMARY

A method, system and computer program product are provided for facilitating discovery and re-use of information constructs.

In an embodiment, there is provided a method for facilitating discovery and re-use of information constructs. The method includes providing an information construct database including a plurality of generic (platform and implementation independent) information constructs. An access interface is provided for allowing a user to access the information construct database. The access interface includes a discovery interface, a selection interface, an acquisition interface and a publication interface. The discovery interface is provided for allowing the user to discover one or more desired information constructs in the information construct database. The selection interface is provided for allowing the user to add the one or more desired information constructs to a list of selected information constructs. The acquisition interface is provided for allowing the user to acquire the information constructs added to the list of selected information constructs in one or more desired formats. The publishing interface is provided for allowing the user to publish one or more information constructs in an available format to the information construct database. A transformation layer exists to map published information constructs to the generic format used in the information construct database. The transformation layer also transforms a generic information construct to the specific format requested by the user via the acquisition interface.

In another embodiment, there is provided a system for facilitating discovery and re-use of information constructs. The system includes an information construct database and an access interface. The access interface allows the user to access the information construct database. The access interface includes a discovery interface, a selection interface, an acquisition interface and a publication interface. The discovery interface allows the user to discover one or more desired information constructs in the information construct database. The selection interface allows the user to add the one or more desired information constructs to a list of selected information constructs. The acquisition interface allows the user to acquire the information constructs added to the list of selected information constructs in one or more desired formats. The publishing interface allows the user to publish one or more information constructs in an available format to the information construct database.

In another embodiment, the present invention provides a computer program product including a computer usable medium having computer program logic recorded thereon for controlling at least one processor, the computer program logic including computer program code means that perform operations similar to the above-mentioned method and system embodiments.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The features and advantages of the present invention will become more apparent from the detailed description set forth below when taken in conjunction with the drawings. The left-most digit(s) of a reference number identifies the drawing in which the reference number first appears.

FIG. 1 is an exemplary system for facilitating discovery and re-use of information constructs according to an embodiment of the present invention;

FIG. 2 is an exemplary illustration of a discovery interface according to an embodiment of the present invention;

FIG. 3 is an exemplary illustration of a selection interface according to an embodiment of the present invention;

FIG. 4 is an exemplary illustration of an acquisition interface according to an embodiment of the present invention;

FIG. 5 is an exemplary illustration of a publishing interface according to an embodiment of the present invention;

FIG. 6 is an exemplary flowchart of a process for facilitating discovery and re-use of information constructs according to an embodiment of the present invention;

FIG. 7 is an exemplary flowchart of an acquisition process according to an embodiment of the present invention;

FIG. 8 is an exemplary flowchart of the acquisition process according to another embodiment of the present invention;

FIG. 9 is an exemplary flowchart of a publication process for publishing one or more information constructs to an information construct database via the publishing interface according to an embodiment of the present invention; and

FIG. 10 is a block diagram of an exemplary computer system for implementing the present invention.

FIGS. 11 and 12 illustrate exemplary taxonomies according to an embodiment of the present invention.

FIG. 13 illustrates an exemplary ontology according to an embodiment of the present invention.

FIG. 14 illustrates an acquisition interface according to an embodiment of the present invention.

Embodiments of the invention will be described with reference to the accompanying drawings. The drawing in which an element first appears is typically indicated by the leftmost digit(s) in the corresponding reference number.

### DETAILED DESCRIPTION

### I. Overview

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

Embodiments of the present invention are directed to a system, method and computer program product for facilitating discovery and re-use of information constructs to assemble an information model.

An information modeling tool provides a platform for assembling the information model using multiple information constructs. Information modeling tools commonly, but not exclusively, represent information models graphically with information constructs represented as distinct graphical artifacts. Currently, many information modeling tools, such as PowerDesigner by Sybase, Inc. of Dublin, Calif., Rational Rose by IBM Corp. of Armonk, N.Y., ER/Studio by Embarcadero Technologies, Inc. of San Francisco, Calif., and so on, are available. IgniteXML by DigitalML-USA Inc. of San Francisco, Calif., provides an example of an information modeling tool that does not currently utilize a graphical representation of the information model. A developer of the information model may add, remove, and maintain appropriate information constructs within the information model using the above mentioned tools.

The terms “user”, “developer” and/or the plural form of these terms are used interchangeably throughout herein to refer to those persons or entities capable of accessing, using, being affected by and/or benefiting from the information constructs database that the present invention provides for discovering and acquiring a plurality of information constructs into a plurality of information models.

The terms “information modeling tool” and “information modeling environment” and/or the plural form of these terms are used interchangeably throughout herein to refer to those platforms which enable assembling of information models.

### II. System Overview

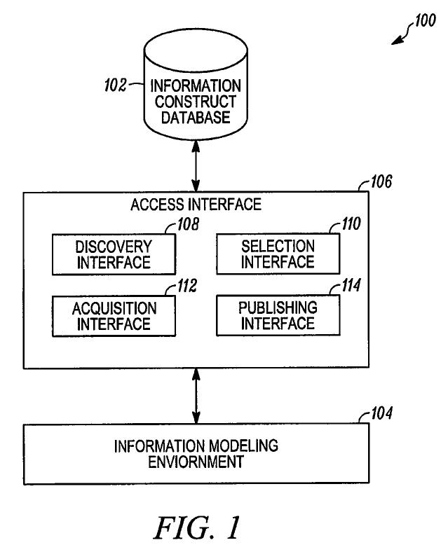

FIG. 1 shows an exemplary system 100 for facilitating discovery and re-use of information constructs according to an embodiment of the present invention. System 100 includes an information construct database 102, an information modeling environment 104, and an access interface 106.

The information construct database 102 stores a plurality of information constructs. The system 100 enables a user to discover and re-use the plurality of information constructs. The plurality of information constructs may be represented in different formats. Examples of the formats include, but are not limited to, JAVA™ Class, XML Schema Definition (XSD) Complex Type, Unified Modeling Language (UML) Class, a Relational Database Management System (RDBMS) table. A person skilled in the art will appreciate that the list of formats mentioned above is for exemplary purposes only and the plurality of information constructs may also be represented in other formats known in the art. In one embodiment of the present invention, the information construct database 102 may publish an information construct in more than one format. For example, an information construct named “PRODUCT” may be published both as a JAVA™ Class and an XSD Complex Type. Accordingly, the plurality of information constructs may include constructs of varying formats.

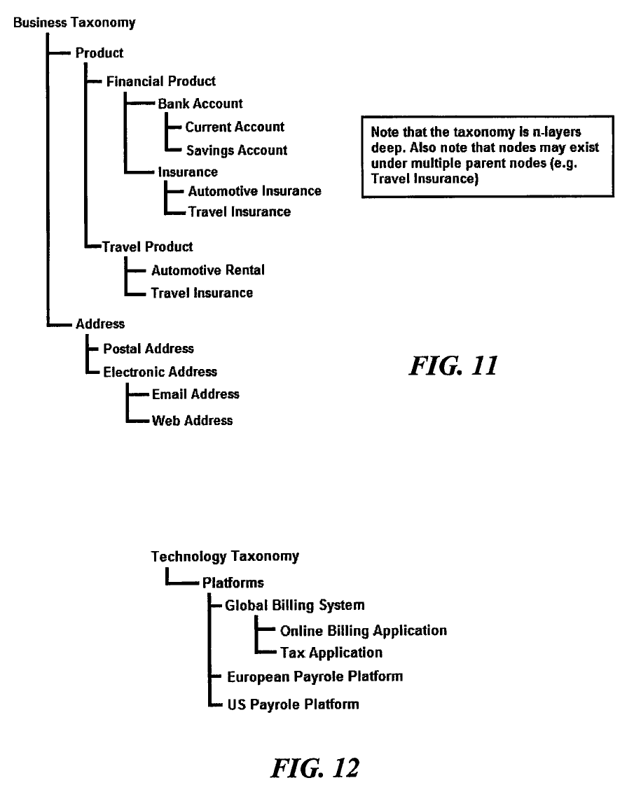

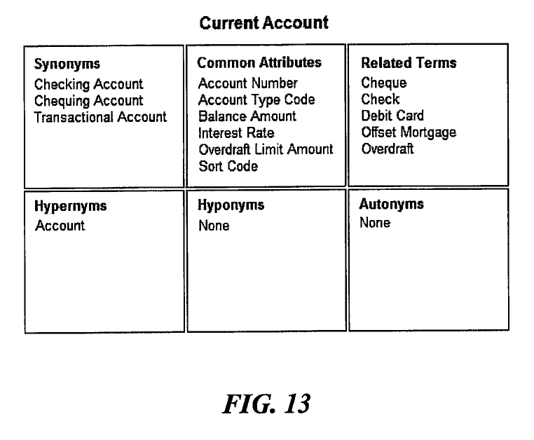

The information construct database 102 further stores metadata information for the plurality of information constructs. Examples of the metadata information for an information construct may include, but are not limited to, date of creation of an information construct, a brief description of the information construct, one or more community driven classes (“tags”) assigned to the information construct, community driven ratings assigned to the information construct, one or more prescriptive taxonomy or ontology classes assigned to the information construct, an acquisition count, an acquisition percentage, lineage information associated with the information construct and so on. The specific metadata fields that are captured in the information construct database may depend on the specific implementation of the database, or may be modified dynamically by an administrator user (dynamic metamodel). For each metadata field, the administrator users may also determine the optionality, cardinality, data type and set of allowable metadata values. For example, the administrator user may introduce a new mandatory metadata field named “scope” in which the valid values are “enterprise,” “platform,” and “application.” The acquisition count indicates a number of times the information construct has been acquired. The acquisition percentage represents a ratio of a number of times the information construct acquired to a number of times the information construct viewed in percentage terms. For a particular information construct, the lineage information includes references to information constructs from which the particular information construct is derived and/or references to information constructs that are derived from the information construct. In an exemplary implementation, the lineage information is stored in a hierarchical structure. Multiple users of the system 100 may assign one or more community driven classes and ratings to an information construct. This process is commonly known as “tagging.” Examples of the one or more community driven classes include ‘customer’, ‘enterprise’, ‘account’, ‘product’ and the like. The user community of the system 100 may thereby classify together various information constructs that, for example, describe a commonly used entity such as ‘customer’ but that might be named differently. Additionally, the user community of the system may use the tagging process to highlight where an information construct reflects multiple business concepts, not all of which may be apparent from its name. Additionally, the user community of the system may use the tagging process to highlight where an information construct represents a business concept is known by different terminology in different parts of the enterprise. A user may use this classification to browse through different information constructs that represent the concept of, say, ‘customer,’ to select the one that is most useful to him/her. Alternatively the user may browse the ‘enterprise’ classification to easily identify all information constructs that have been defined at an enterprise level. Each of the plurality of information constructs may be assigned to one or more nodes on one or more prescriptive taxonomies or ontologies. Examples of such taxonomies include a taxonomy of business lexicon (see FIG. 11) or a taxonomy of technology assets within an enterprise(see FIG. 12). An example ontology is illustrated in FIG. 13.

The information modeling environment 104 enables the user to assemble a target information model using multiple information constructs. In one embodiment of the present invention, information modeling environment 104 may be implemented as desktop software and is stored locally on the user's computing system, for example, a Personal Computer (PC), a laptop, a Personal Digital Assistant (PDA) and so on. In another embodiment of the present invention, information modeling environment 104 is implemented on a server. In this case, the user may access the information modeling environment 104 over a network using a web browser, widget, plug-in for a development environment, or a custom client. The network may be, without limitation, a wide area network (WAN), a local area network (LAN), an Ethernet, the Internet, an Intranet and combinations thereof. The execution of the code associated with the information modeling environment may be on the server, the client, or any combination thereof. Examples of the web browsers may include, but are not limited to, the INTERNET EXPLORER™ browser by Microsoft Corp. of Redmond, Wash., the NETSCAPE NAVIGATOR™ browser by AOL, LLC of New York, N.Y., the FIREFOX™ browser by Mozilla Foundation of Mountain View, Calif., the OPERA™ browser by Opera Software ASA of Oslo, Norway, the CHROME™ browser by Google, Inc. of Mountain View, Calif., and so on. Examples of development environments may include, but are not limited to, ECLIPSE™ by the Eclipse Foundation of Ottawa, ON, VISUAL STUDIO™ by Microsoft Corp. of Redmond, Wash., and so on.

The access interface 106 enables the user to access the information construct database 102. The user interacts with the information construct database 102 for discovery and re-use of the plurality of information constructs by performing various actions through the access interface 106. In an exemplary case, the access interface 106 may be implemented as a web interface and is rendered in a web browser. In another exemplary case, access interface 106 may be implemented within an information modeling environment interface. In this case, the access interface 106 allows the user to access the information construct database 102 directly via the information modeling environment 104. In one embodiment of the present invention, the information modeling environment 104 interface may be implemented as a plug-in to the information modeling environment 104.

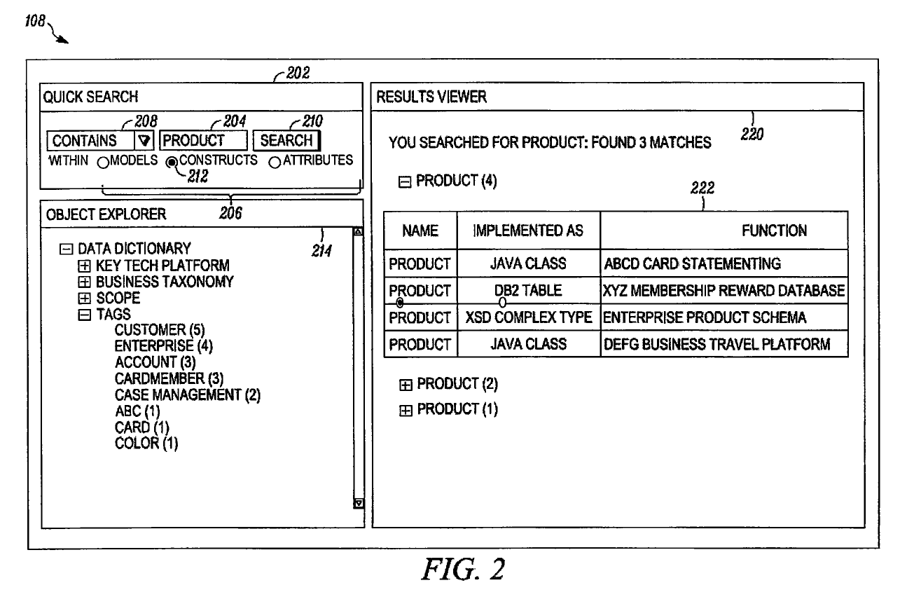

The access interface 106 includes a discovery interface 108, a selection interface 110, an acquisition interface 112, and a publishing interface 114. The discovery interface 108 facilitates the user to discover one or more desired information constructs in the information construct database 102. According to one embodiment of the present invention, the discovery interface 108 includes a search interface. The search interface enables the user to discover the desired information constructs by searching through the information construct database 102 using one or more keywords. The search results may be limited by restricting the search across one or more types of objects stored in the information construct database. For example, information constructs, the information models in which the plurality of information constructs are implemented, or attributes/properties of the information constructs. Additionally, use of advanced search criteria may be used to further narrow the search results. Advanced search criteria may restrict the keyword search to one or more metadata fields. For example, name, description, the community driven classes, the prescriptive taxonomy classes, and so on. Furthermore, advanced search criteria may be combined through use of Boolean search operators such as “AND,” “NOT,” and “OR.” The discovery interface 108 further includes a navigation interface. In an exemplary case, the user may navigate through the information construct database 102 using the navigation interface based upon community driven classes assigned to the plurality of information constructs for discovering the desired information constructs. In another example, the navigation interface may enable the user to browse the information construct database 102 based upon the prescriptive taxonomy classes or the lineage information. An exemplary implementation of the discovery interface 108 including the search interface and the navigation interface is explained in conjunction with FIG. 2.

The selection interface 110 enables the user to add the desired information constructs to a personal list of selected information constructs. The list of selected information constructs is a list of information constructs selected by the user in a current session. In an embodiment of the present invention, the list of selected information constructs may be implemented as an online shopping cart. The online shopping cart may be persistent for the current session of the user, or even across multiple sessions for the user. In an exemplary implementation, when the desired information constructs are available in multiple formats, the selection interface 110 also allows the user to choose a desired format for each of the desired information constructs. The formats may be well-known common formats such as Structure Query Language (SQL) or XML Schema Definition (XSD), or they may be tool-specific formats such as ‘ER/Studio Logical Model.’

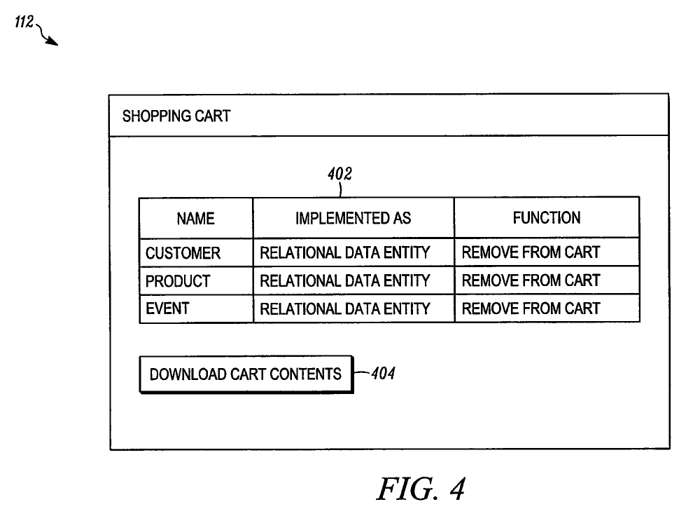

The acquisition interface 112 allows the user to acquire information constructs present in their personal list of selected information constructs. An exemplary implementation of the acquisition interface 112 is described in conjunction with FIG. 4. In one embodiment of the present invention, the acquisition interface 112 may enable the user to specify one or more desired formats that are different from one or more available formats for the information constructs. In this case, the acquisition interface 112 converts the information constructs represented in the available formats into the desired formats. The user may then reuse the acquired information constructs by incorporating them into an existing information model or by creating a new information model. The user may also modify the acquired information constructs before reusing these information constructs. For example, the user may modify the list of attributes associated with the information construct or the data types of those attributes.

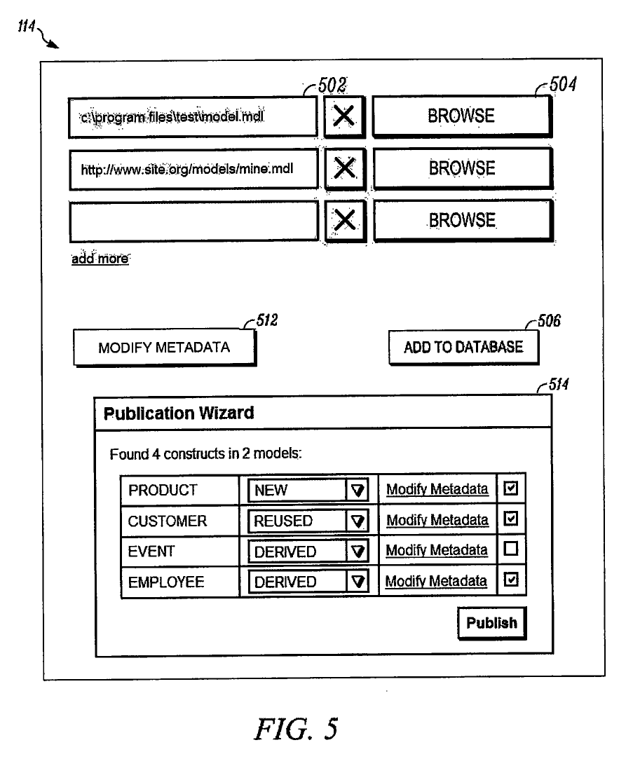

In an embodiment of the present invention, the user may add a new information construct or a modified information construct to the information construct database 102. The publishing interface 114 enables the user to add information constructs to the information construct database 102. The publishing interface 114 is able to identify whether the information constructs are new, reused in an unmodified state, or derived from a reused construct. Methods for identification of reused information constructs may include custom metadata attributes and/or comparison of name and structure with constructs in the information construct database. In one embodiment, the user may select an existing information model through the publishing interface 114, for example, by entering a URL or browsing a computer file system. The publishing interface 114 is able to extract individual information constructs from the information model and determine reuse as described above. In another embodiment, where the publishing interface 114 is integrated with the information modeling environment, the user can select individual information constructs through the publishing interface 114 and add the information constructs to the information construct database 102. In another embodiment, the user publishes information models and information constructs to the proprietary repository associated with their information modeling tool. The publication interface 114 communicates with the proprietary repository and uses the metadata stored in the proprietary repository to publish the relevant information constructs in the information construct database. Examples of communication include, but are not limited to, RESTful Web service, RSS feed, proprietary API, etc., and may take the form of either a live or a batch process. Regardless of the publication process, the user may also add the metadata information and the lineage information for the added information constructs through the publication interface 114. An exemplary implementation of the publishing interface 114 is explained in conjunction with FIG. 5.

The system 100 may further include a resource generation module, a link generation module, and a file generation module, not shown in the FIG. 1. The resource generation module generates resources in response to the user acquiring the information constructs in the list of selected information construct through the acquisition interface 112. The resources include the acquired information constructs. The link generation module generates a Uniform Resource Locator (URL) for each of the resources, wherein the URL points to the corresponding resource. The file generation module generates downloadable files, which contain the one or more resources including the information constructs present in the selected information constructs list. In one embodiment of the present invention, the resource generation module, the link generation module and the file generation module are implemented as software accessed by the acquisition interface 112. The user downloads the acquired information constructs using either the URL or the downloadable file and incorporates the acquired information constructs into the target information models.

In one embodiment of the present invention, the system 100 is deployed within an organization. In this case, the information construct database 102 may reside on, but is not limited to, an intranet, a LAN or a WAN of the organization and is accessible to employees of the organization. In another embodiment of the present invention, the system 100 may be deployed by a third-party service provider for enabling users from multiple organizations to share information constructs. In this case, the information construct database 102 may reside on a web server and may be accessed via the Internet. The third-party service provider may also charge the users or the organizations for accessing the information construct database 102. In addition, according to an exemplary implementation each user may have a separate login and password for accessing the information construct database 102. Alternatively, an organization may share one or more logins and passwords for its employees.

FIG. 2 is an exemplary illustration of the discovery interface 108, in accordance with an embodiment of the present invention. The discovery interface 108 includes a search interface 202 and a navigation interface 214.

Search interface 202 includes a search box 204, one or more search fields, options, or filters 206 (hereinafter filters), a drop-down menu 208, and a “Search” button 210. In one embodiment of the present invention, the user inputs the one or more keywords in the search box 204 using various input devices known in the art. Further, the user optionally restricts their search to a single type of objects stored in the information construct database 102 by clicking a corresponding radio button of the radio buttons 212. According to an embodiment of the present invention, the filters 206 include, but are not limited to, models, search fields, constructs and attributes, as described in conjunction with the access interface 106 of FIG. 1. In one example, the user can limit their search to more than one type of the objects stored in the information construct database. In this example, the radio buttons 212 may be replaced by check boxes 212. The user may also specify further filters in the drop-down menu 208. Various search filters provided in the drop-down menu 208 include, but are not limited to, “Contains”, “Does not contain”, “Begins with”, “Does not begin with”, “Equals”, and “Does not equal”. The search filters mentioned above are well known in the art and a person skilled in the art will recognize various other search options that may be provided by drop-down menus, radio buttons, check boxes, sliders or other user interface widgets. 208. In an example shown in the FIG. 2, the user searches for information constructs that contain the keyword “PRODUCT”. Though in the example shown, the user may not restrict their search to one or more search fields (e.g. name, description, taxonomic categorization), a person skilled in the art will appreciate that an advanced search dialog could allow the user to restrict their search to one or more search fields. The user can initiate the search for the desired information constructs by activating the “Search” button 210 using various techniques known in the art. One of skill in the art will recognize that other fields, user interface widgets and search layouts may be utilized instead without departing from the spirit and scope of the present invention. The quality of the search results may be improved through the use of fuzzy logic, for example using known synonyms and related terms from an enterprise ontology.

The user may also discover the desired information constructs by navigating the information constructs database 102 using the navigation interface 214. In an embodiment of the present invention, the navigation interface 214 displays a tree view corresponding to one or more of the prescriptive taxonomy, or the community driven classes. Different nodes and sub-nodes of the tree view represent classes and sub-classes of the prescriptive taxonomy or the community driven classes. Based upon a selection by the user, the nodes and sub-nodes may be expanded or collapsed to enable the user to browse the tree view. For example, as shown in FIG. 2, a node “Tags” of the tree view represents the community driven taxonomy and multiple sub-nodes of “Tags” represent various community driven classes of the community driven taxonomy. A number of information constructs available in each community driven class may also be displayed to the user, according to an embodiment of the present invention. In an example shown in FIG. 2, community driven class “CUSTOMER” contains five information constructs represented by a numeric 5 in the parenthesis. The navigation interface may be dynamically updated in accordance with changes to the classification of information constructs and changes to the prescriptive and community driven taxonomies.

The tree view in the navigation interface 214 may be implemented using various techniques known in the art. Moreover, a person skilled in the art will appreciate that the tree view is only an exemplary way to present a hierarchical structure of the prescriptive taxonomy or the community driven taxonomy to the user and various other techniques known in the art may also be used.

The discovery interface 108 further includes a Results Viewer panel 220 for displaying a result set of the discovery performed by the user. As described above, the discovery may be performed using any combination of the basic search interface 202, an advanced search interface, and the navigation interface 214. The results viewer panel 220 displays the user's search query and a number of hits matching the user's search query. According to an embodiment of the present invention, a result set for each hit may be displayed in a tabular manner. The table 222 shown in the FIG. 2 is an exemplary representation of such a table presenting the result set. In one embodiment of the present invention, the table 222 presents one or more fields for each information construct in the result set. Examples of the fields include a name of an information construct, the formats in which the information construct is currently implemented, and the names of (and links to) any information models in which the information construct is used, represented in the table 222 by columns “NAME”, “IMPLEMENTED AS”, and “FUNCTION”, respectively. The results viewer panel 220 also enables the user to group the result set of information constructs. In an embodiment of the present invention, the discovered information constructs having similar names may be grouped together into one result set. In another embodiment of the present invention, the discovered information constructs with similar structure may be grouped together. In yet another embodiment of the present invention, the search results having similar names as well as structures may be grouped together. The result set may also be grouped intelligently into groups of likely similar structures according to fuzzy logic, for example using known synonyms from an enterprise ontology or by comparison of data types.

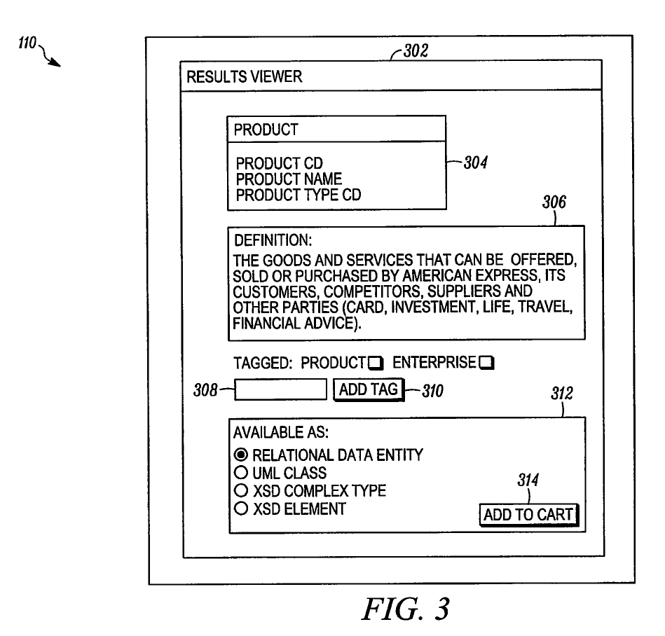

FIG. 3 is an exemplary graphical illustration of the selection interface 110, in accordance with an embodiment of the present invention. The system 100 allows the user to select information constructs from the desired information construct database and add the selected information constructs to a personal list of information constructs using the selection interface 110. This list may take the form of a shopping cart or a favorites list. In an embodiment of the present invention, the selection interface 110 is presented to the user, when the user clicks on one or more information constructs in the result set displayed in the results viewer panel 220. The selection interface 110 includes a structure field 304, a definition field 306, a tag box 308, an “ADD TAG” button 310, a format selection field 312 and an “ADD TO CART” button 314.

The structure field 304 displays a name of the selected information construct, zero or more primary key attributes for the selected information construct, and zero or more non-key attributes of the entities. As shown in an example of the FIG. 3, the information construct “PRODUCT” includes a primary key of “PRODUCT CD” with non-key attributes “PRODUCT NAME” and “PRODUCT TYPE CD”. The definition field 306 provides a brief definition of the selected information constructs. The brief definition may describe properties and applications of each of the selected one or more information constructs. In one embodiment of the present invention, the user may add a tag (community driven class) to the selected information construct, by entering the tag into the tag box 308 and clicking on the “ADD TAG” button 310. The format select field 312 displays one or more formats in which the selected information construct is available for acquisition. The format select field 312 also includes a radio button for each of the available formats. The user may select a desired format of the selected information construct by clicking a radio button corresponding to the selected format, before adding the selected information construct. In one embodiment of the present invention, the user may also select more than one desired formats. In this case, the radio buttons may be replaced by check boxes. The selected information construct represented in the desired format is added to the list of selected information construct, for example, but not limited to, a shopping cart, by clicking on the “ADD TO CART” button 314. In an exemplary implementation, when the user has selected a desired format for the selected information construct, the information construct is converted from a generic format in which it is stored to the desired format before adding the selected information construct to the shopping cart, as long as the correct mapping is known for the information construct. If a user cannot select a particular format, it is because either the application does not know the mapping or for some reason it is not possible to map the construct to the desired format.

According to one embodiment of the present invention, the results viewer panel 220 may include a check box for each of the desired information constructs displayed in the results viewer panel 220 and the “ADD TO CART” button 314. The user can add the desired information constructs by clicking on corresponding check boxes and then clicking on the “ADD TO CART” button 314. Alternatively, the results viewer panel 220 may provide an “ADD TO CART” link for each information construct in the result set and the user can add the desired information construct to the online shopping cart by simply clicking on this link. In these cases, the results viewer panel 220 may be treated as the selection interface 110. A person skilled in the art will appreciate that the implementations given above are for exemplary purposes only and various other options may be provided in the selection interface 110 for enabling the user to add the discovered information constructs to the list of information constructs.

Embodiments of the invention may include the capability to store and manage personal and group-level favorites lists. The user may directly access a favorites list in order to rapidly access commonly used information constructs. The results viewer panel 220 may provide an “ADD TO FAVORITES” link for each information construct in the result set and the user can add the desired information construct to their personal favorites list by clicking on this link. A person skilled in the art will appreciate that the implementation given above is for exemplary purposes only and various other options may be provided in the selection interface 110 for enabling the user to add the discovered information constructs to the list of information constructs. In another embodiment, favorites lists may be additionally defined at a group level (for example, shared within a department or across an enterprise). An administrator user can add common information constructs to a group-level favorites list in order to provide all members of that group easy access to the same list of information constructs. In another embodiment, the favorites lists (personal or group-level) are wholly or partially dynamically populated. In this case, the system identifies which information constructs are commonly reused by the user or group of users and adds them to the appropriate favorites list.

FIG. 4 is an exemplary illustration of the acquisition interface 112, in accordance with an embodiment of the present invention. As mentioned earlier, the user acquires the information constructs in the list of selected information constructs using the acquisition interface 112. The acquisition interface 112 includes a table 402 and a “DOWNLOAD CART CONTENTS” button 404. The table 402 displays a list of information constructs added to the list of selected information constructs to the shopping cart. In an exemplary case, the table 402 displays name and format of each information construct added to the shopping cart. The table 402 also provides a functional option for each information construct. According to an example shown in the FIG. 4, “REMOVE FROM CART” option is provided for each information construct for removing the information construct from the shopping cart. A person skilled in the art will recognize other functional options that may be provided, for example, linking the information construct to the user's favorites list. The user may initiate an acquisition process for acquiring the information construct in the shopping cart into the target information models by clicking on the “DOWNLOAD CART CONTENTS” button 404.

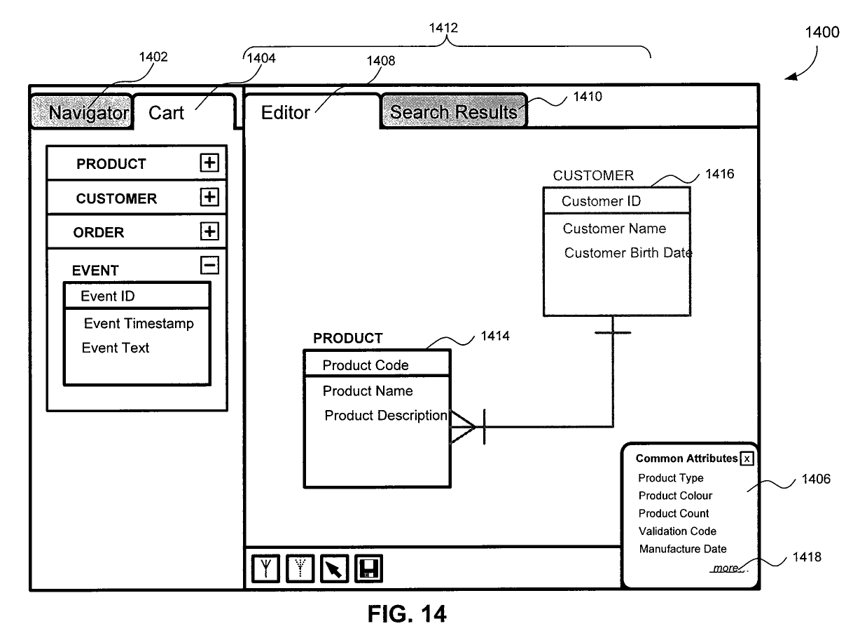

FIG. 14 is an exemplary illustration of an acquisition interface 1400 according to an embodiment of the present invention. In various examples, acquisition interface 1400 is either integrated with a web-based modeling tool or is provided as a plug-in for a client-based modeling tool or development environment. Acquisition interface 1400 appears adjacent to the main view of the information modeling tool (henceforth known as the EDITOR). Acquisition interface 1400 can include two tabs, “NAVIGATOR” 1402 and “CART” 1404, and a COMMON ATTRIBUTES panel 1406. In one example, when active (not shown), navigator tab 1402 has comparable functionality and appearance to the Quick Search 202 and Object Explorer 214. When active, the cart tab 1404 can display a list of information constructs added to the user's personal list of selected information constructs (shopping cart). The user may click the maximize button to display further details of a specific information construct in the shopping cart. Persons skilled in the art will appreciate that an editor tab 1408 is representative of a typical, third-party information modeling tool (in this case an entity relationship diagram is displayed) and is not intended to represent any specific information modeling tool or its features. In this embodiment, the EDITOR 1408 and SEARCH RESULTS 1410 appear as tabs occupying the same panel 1412. In one example, when active (not shown), search results tab 1410 has comparable functionality and appearance to the Results Viewer 220. In order to incorporate an information construct from the shopping cart into a new or existing information model, the user may use their input device to drag-and-drop an information construct from the CART tab 1404 to a model currently displayed in the EDITOR tab 1408. In the case of FIG. 14, the user has dragged the information constructs PRODUCT 1414 and CUSTOMER 1416 into the editor 1408. Once an information construct is visible in the editor 1408, the user may use any of the functionality of the information modeling tool to edit or augment the information construct. In the case of FIG. 14, the user has created a relationship between the PRODUCT 1414 and CUSTOMER 1416 information constructs.

In one example, COMMON ATTRIBUTES panel 1416 uses the information construct database 102 to populate a list of the most common attributes associated with information constructs that are similar to the information construct currently selected in the editor 1408. Similar information constructs may be identified by name or according to fuzzy logic, for example, using a combination of structure, relationships and known synonyms from an enterprise ontology. In the case of FIG. 14, the user has selected the PRODUCT information construct 1414 and the common attributes panel 1416 is displaying five attributes commonly associated with PRODUCT 1414. These attributes have been identified as likely candidates for reuse in the PRODUCT information construct displayed in the editor, based on its current attributes (Product Code, Product Name and Product Description) and the nature of its relationship to CUSTOMER. The user can display additional attributes (of decreasing relevancy) by selecting the “MORE” link 1418. In order to incorporate an attribute from the common attributes list into an existing information construct, the user may use their input device to drag-and-drop an attribute from the common attributes panel 1406 to an information construct currently displayed in the editor tab 1408.

The user may build an information model by designing new information constructs or re-using acquired information constructs. The user may also modify the acquired information constructs before incorporating into the information model. The system 100 facilitates the user to publish the new information constructs or the modified information constructs to information construct database. In one embodiment of the present invention, the system 100 provides the publishing interface 114 to the user enabling the user to add information constructs to the information construct database 102.

FIG. 5 is an exemplary illustration of the publishing interface 114, in accordance with an embodiment of the present invention. The publishing interface 114 includes a text box 502, a “BROWSE” button 504, and an “ADD TO DATABASE” button 506. The user selects at least one information model that contains one or more information constructs to be added to the information construct database 102 using the text box 502, or the “BROWSE” button 504, according to an embodiment of the present invention. In an exemplary case, the user may directly enter a path to the at least one information construct in the text box 502. Alternatively, the user may directly enter a URL pointing to the at least one information construct. The publication interface 114 may also allow the user to browse through multiple information models stored locally to the user's computing system or on a web server for selecting the at least one information model by clicking on “BROWSE” button 504. In this case, the user is provided a browser window that is well known in the art. Upon selection by the user, the text box 502 may display the path or the URL to the at least one information construct. The user adds the chosen information model(s) to the information construct database 102 by clicking on the “ADD TO DATABASE” button 506.

The publishing interface disassembles the chosen information models into their constituent information constructs and related metadata. The publishing interface is able to identify whether the information constructs are new (NEW), used in an unmodified state (REUSED), or derived from a reused construct (DERIVED). As discussed above, there are multiple methods that may be used individually or in combination to achieve this function. The publishing interface presents the user with a list of all information constructs that were identified in the published models together with whether they are NEW, REUSED, or DERIVED. If the information is DERIVED or REUSED, the publishing interface may also provide a link to the information construct within the database from which the published information construct is derived or reused. The user has the option of overriding the dynamically determined classification of NEW, REUSED, or DERIVED. In the case where the user manually selects a classification of REUSED or DERIVED, they may be prompted to search/browse the information construct database for the information construct from which the published construct is derived or reused. The user has the option of selecting, by check boxes or other means, which of the identified information constructs will be published in the information construct database.

At this stage, the publishing interface 114 may also include a “MODIFY METADATA” link 512 for allowing the user to modify metadata captured by the information modeling environment or to enter additional metadata information (i.e., beyond that captured by the information modeling environment) corresponding to each of the identified information constructs. This metadata may include lineage information. In one embodiment, the user may be presented a separate interface when the user clicks on “MODIFY METADATA” link 512. According to an exemplary implementation, the publishing interface 114 also displays information about the information construct added to the information construct database 102 in a current session of the user in a tabular manner. The table 514 shown in FIG. 5 is an exemplary representation of such a table. For each information construct added to the information construct database 102 in the current session, the table 514 displays a name of an information construct, an available format of the information construct and a name of an information model in which the information construct is used, in columns “NAME”, “IMPLEMENTED AS”, and “FUNCTION”, respectively. In the case where an information construct is identified as NEW, the information construct will be added to the information construct database and will be available for discovery and reuse by other users. The information construct will have only a single implementation that matches the type of information construct (e.g., XML Schema Complex Type, Database Table, or UML Class) that has just been published. In the case where an information construct is identified as REUSED, a new implementation is created for the existing information construct. The new implementation will match the type of information construct that has just been published. In the case where an information construct is identified as DERIVED, a new information construct will be added to the information construct database and will be available for discovery and reuse by other users. There will be a navigable relationship between the new information construct and the construct from which it is derived.

### III. Process Overview

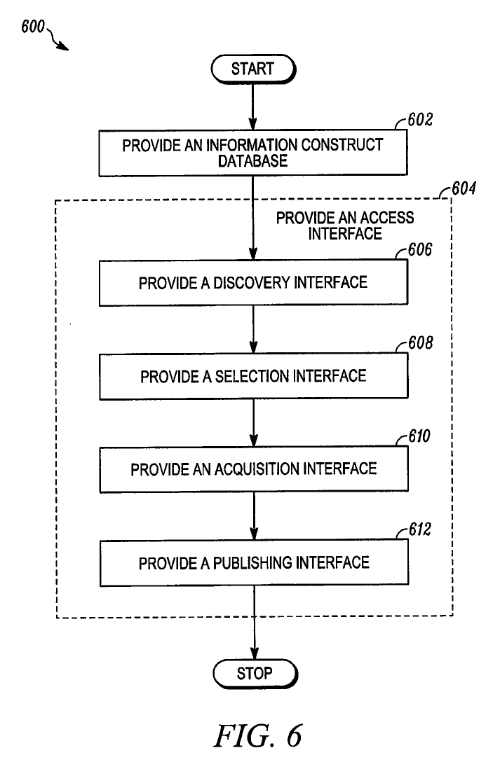

FIG. 6 is a flowchart illustrating an exemplary process 600 for facilitating discovery and re-use of information constructs, in accordance with an embodiment of the present invention. In step 602, an information construct database, for example the information construct database 102, is provided. The information construct database 102 includes a plurality of information constructs represented in different formats. Examples of the formats include, but are not limited to, JAVA™ Class, XML Schema Definition (XSD), Unified Modeling Language (UML) Class, a Relational Database Management System (RDBMS) table and the like. In addition, the metadata information for each information construct of the plurality of information constructs is also maintained by the information construct database 102.

In step 604, the access interface 106 is provided to the user for allowing the user to access the information construct database 102. In an embodiment of the present invention, the access interface 106 is implemented as a web interface. In this case, the user may access the access interface 106 using a web browser. In another embodiment of the present invention, the access interface 106 is provided as an information modeling environment interface. In this case, the access interface 106 may be accessed by the user directly from the information modeling environment. The user interacts with the access interface 106 for performing different functions as envisaged by various embodiments of the present invention. The different functions include, but are not limited to, discovering one or more desired information constructs, adding the desired information constructs to a list of selected information constructs, acquiring information constructs added to the list of selected information constructs and adding one or more information constructs to the information construct database 102 for publishing the one or more information constructs. In one embodiment of the present invention, the access interface 106 includes one or more interfaces for performing the different functions and the system 100 provides the one or more interfaces to the user.

In step 606, a discovery interface, such as the discovery interface 108, is provided to the user for allowing the user to discover the desired information constructs. A search interface and a navigation interface, such as the search interface 212 and the navigation interface 214, are provided to the user for discovering the desired information construct, according to an exemplary implementation. In one embodiment of the present invention, the user may discover the desired information constructs via the search interface using keyword based searching. The user may input one or more keywords to perform searches in different search fields, such as Models, Entities or Attributes and the like. The one or more keywords used to perform the search may be combined using well known Boolean operators such as, AND, OR, AND NOT and the like. In another embodiment of the present invention, the user may choose to navigate the information construct database 102 using the navigation interface for discovering the desired information constructs. The navigation may be done based upon the lineage information, the community-driven classes, or the prescriptive taxonomy classes. In yet another embodiment of the present invention, the user may perform the discovery using both the search interface and the navigation interface. For example, the user may navigate the information construct database 102 to a particular community-driven class using the navigation interface and then conduct a search for the desired information constructs in information constructs in the particular class using the search interface.

Once the user discovers the desired information constructs, the system 100 provides the user with a selection interface at step 608. The user selects the one or more information constructs from the desired information constructs and adds the selected information constructs to the list of selected information constructs using the selection interface. According to one embodiment of the present invention, the selection interface is implemented as the selection interface 110. In an embodiment, the list of selected information constructs is implemented as an online shopping cart. In an embodiment of the present invention, when the desired information constructs are available in multiple formats, the selection interface 110 may provide the user an option to select a desired format for the desired information constructs. In another embodiment, the selection interface 110 may also allow the user to select a desired format that is different from the available format for the desired information constructs, wherein the desired format is compatible to the available format. In this case, the selection interface 110 converts the desired information constructs from the available format to the desired format.

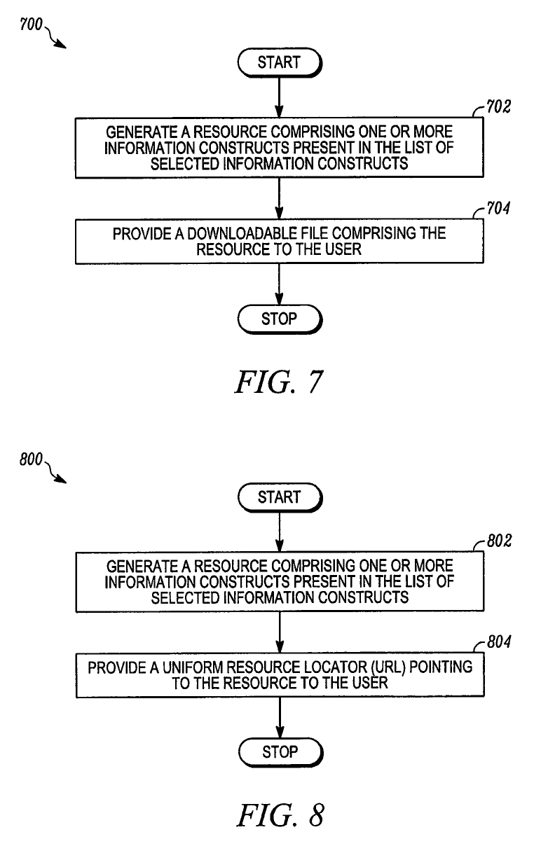

In step 610, an acquisition interface, for example, the acquisition interface 112 is provided to the user for facilitating the user to acquire the information constructs added to the list of selected information constructs into a target information model. The acquisition interface 112 displays the information constructs added to the list of selected information constructs. Furthermore, one or more options may be given to the user for acquiring the information constructs in the list of selected information constructs. For example, the acquisition interface 112 may allow the user to acquire the information constructs directly into the target information model by dragging-and-dropping the information constructs into the target information model. Alternatively, the acquisition interface 112 may provide a “DOWNLOAD CART CONTENTS” button. When the user clicks the “DOWNLOAD CART CONTENTS” button, an acquisition process is triggered for acquiring the information constructs present in the list of selected information constructs represented in the desired formats selected by the user in step 608. Various embodiments of the acquisition process, in accordance with the present invention, are explained in detail in conjunction with FIGS. 7-8. The user may then import the acquired information constructs into the target information model using various techniques known in the art.

In step 612, a publishing interface is provided to enable the user to publish an information construct through the information construct database 102. In an exemplary implementation, the publishing interface 114 is provided to the user. The user selects the information construct to be added to the information construct database 102 using the publishing interface 114. The publishing interface 114 also allows the user to enter the metadata information for the information construct to be published. In addition, the publishing interface 114 may enable the user to add lineage information for the information construct. After adding the information construct to the information construct database 102, the information construct is published. In other words, the information construct then becomes discoverable by the users of the system 100.

FIGS. 7-8 describe different embodiments of the present invention for implementing the acquisition process.

FIG. 7 is an exemplary illustration of implementing the acquisition process 700, in accordance with one embodiment of the invention. In step 702, a resource including the information constructs in the list of selected information constructs is generated. A downloadable file including the resource generated in step 702 is provided to the user at step 704. The downloadable file is generated in a format that is suitable for the user's computing system and the information modeling environment 104 used. In an exemplary case, the downloadable file may be generated in a text (.txt) format, extensible markup language (.xml) format, or any proprietary file format used by the information modeling environment. A person skilled in the art will appreciate that other formats for downloadable file may be used within the scope and spirit of the present invention. The user then downloads the downloadable file to the local computer system. The information constructs in the downloaded file may then be incorporated into the target information model using techniques well known in the art. For example, the user may select the downloaded file using an “OPEN” menu option in information modeling environment 104, and then import the information constructs into the target information model using an “IMPORT” menu option. In another example, the user may open the downloadable file by browsing to a location of the downloaded file in the local computer system and then dragging-and-dropping the information constructs in the downloaded file into the target information model.

FIG. 8 is an exemplary illustration of implementing the acquisition process 700, in accordance with another embodiment of the present invention. In step 802, a resource is generated, wherein the resource includes the information constructs in the list of selected information constructs. In step 804, a Uniform Resource Locator (URL) pointing to the resource is provided to the user. In one embodiment of the present invention, the information modeling environment 104 may allow the user to simply input the URL for importing the information constructs into the target information model. In another embodiment, the user may access the URL and then drag-and-drop the information constructs into the target information model. A person skilled in the art will appreciate that various other methods known in the art for importing the information construct may also be used without deviating from the scope and spirit of the present invention.

There are multiple ways for a user to interact with a remote information construct database in order to acquire specific information constructs. For example, the user may access the information constructs through a modeling environment installed locally on the user's system. Alternatively, the user may access the information constructs through a web-based modeling environment.

The user may use the acquired information constructs in an existing information model or the user may create a new information model using the acquired information constructs. Further, the user may incorporate the acquired information constructs into the target information model without any modifications. Alternatively, the user may modify the acquired information constructs before incorporating the acquired information constructs in the target information model. In an embodiment, the user may only have a limited ability to modify an information construct. For example, the user may not be allowed to modify an information construct which has been designated as a standard information construct for information modeling in an enterprise.

As mentioned above in conjunction with FIG. 1, the system 100 enables the user to add one or more information constructs to the information construct database 102 via the publishing interface 114, in one embodiment of the present invention. Thereafter, the system 100 publishes the added information constructs in information construct database 102. The one or more information constructs may include one or more new information constructs or one or more modified information constructs or both.

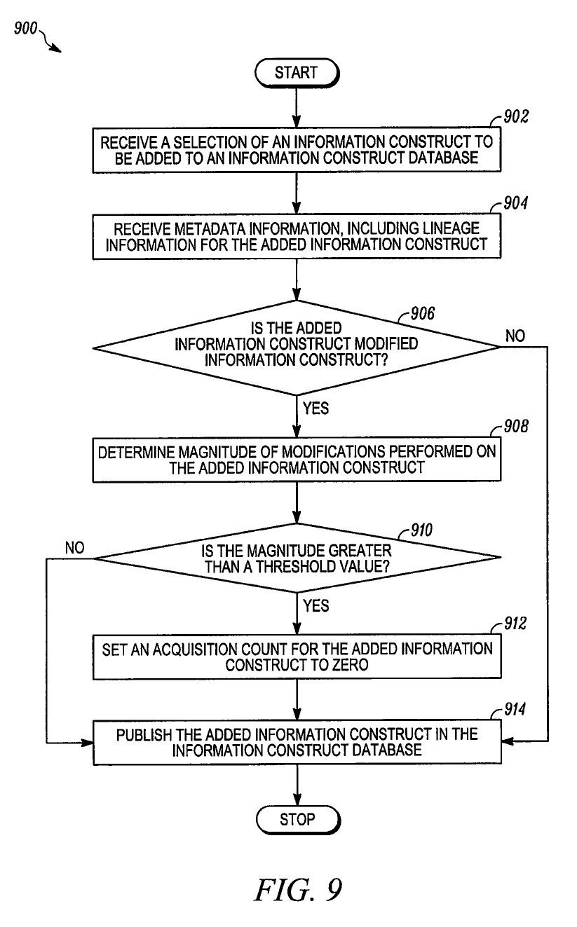

FIG. 9 is a flowchart illustrating an exemplary process 900 for adding the one or more information constructs to the information construct database 102 via the publishing interface 114, in accordance with one embodiment of the present invention. At step 902, the publishing interface 114 receives a selection of an information construct to be added to the information construct database 102 from the user. According to one embodiment, the publishing interface 114 enables the user to select the information construct to be added from multiple information constructs stored on the user's local computing system as described in conjunction with the FIG. 5. In step 904, the publishing interface 114 receives the metadata information, including lineage information of the added information construct from the user. In an exemplary case, the user enters the metadata information by clicking on “ADD METADATA” button. Thereafter, at step 906, the method determines whether the added information construct is modified. In one embodiment of the present invention, selection of radio buttons 508 or 510 is used to make this determination.

If at step 906, it is determined that the added information construct is a modified information construct, then at step 908, the magnitude of modifications performed on the added information construct is computed. The lineage information is used to compare the added information construct with antecedent information constructs of the added information construct. At step 910, the magnitude is compared with a threshold value. In an embodiment of the present invention, the threshold value has a default level, but may be separately defined for individual information constructs, groups of information constructs, or particular types of information constructs. The threshold value is an amalgamation of different factors that may include: new attributes of information construct; removed attributes of information construct; name of information construct; and data types of attributes of information construct. For example, it would be possible to set the threshold such that a published information construct is DERIVED if one or two new attributes are added; DERIVED if any number of data types are modified; and NEW if more than two attributes are added or if any number of attributes are removed. If at step 910, the magnitude is found to be greater than the threshold value, the added information construct is treated as a new information construct by the information construct database 102 and the acquisition count for the added information construct is set to zero at step 912. Thereafter, the added information is published in the information construct database 102 at step 914. If at step 910, the magnitude is found to be less than the threshold value, the added information construct is published in the information construct database 102 at step 914. Also, if at step 906, it is determined that the added information construct is a new information construct, then the added information construct is published in the information construct database 102 at step 914.

### IV. Example Implementations

Embodiments of the present invention or any part(s) or function(s) thereof) may be implemented using hardware, software or a combination thereof and may be implemented in one or more computer systems or other processing systems. However, the manipulations performed by embodiments of the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

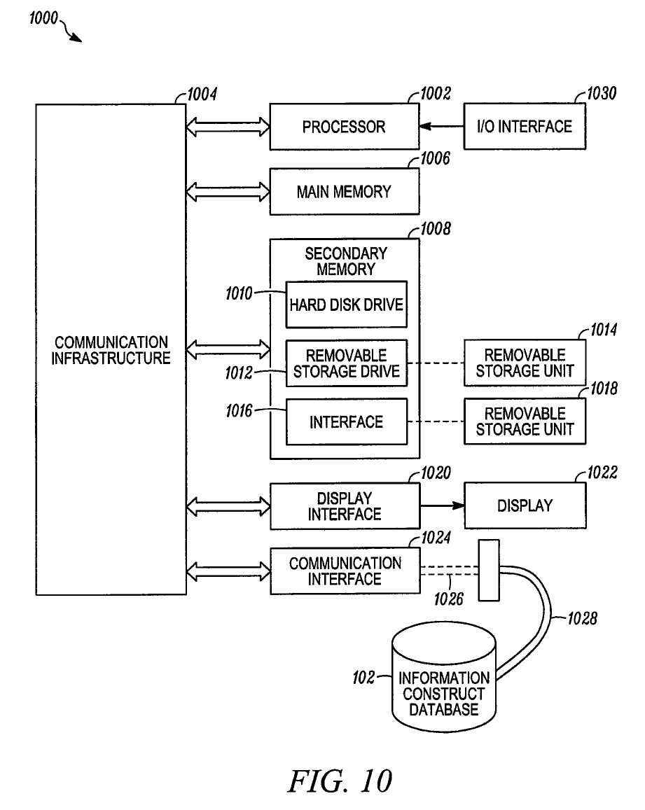

In fact, in one embodiment, the invention is directed toward one or more computer systems capable of carrying out the functionality described herein. An example of a computer system 1000 is shown in FIG. 10. The computer system 1000 includes one or more processors, such as the processor 1002. The processor 1002 is connected to a communication infrastructure 1004 (for example, a communications bus, a cross-over bar, or a network). Examples of the processor 1002 may be, without limitation, an ATHLON™ microprocessor from Advanced Micro Devices (AMD) or a PENTIUM™ based processor from Intel. Various software embodiments are described in terms of this exemplary computer system. After reading this description, it will become apparent to a person skilled in the relevant art(s) how to implement the invention using other computerized information modeling systems and/or architectures.

Computer system 1000 also includes a main memory 1006, preferably random access memory (RAM), and may also include a secondary memory 1008. The secondary memory 1008 may include, for example, a hard disk drive 1010 and/or a removable storage drive 1012, representing a floppy disk drive, a magnetic tape drive, an optical disk drive, and the like. The removable storage drive 1012 reads from and/or writes to a removable storage unit 1014 in a well known manner. The removable storage unit 1014 represents a floppy disk, a magnetic tape, an optical disk, and the like which is read by and written to by the removable storage drive 1014. As will be appreciated, the removable storage unit 1014 includes a computer usable storage medium having stored therein computer software and/or data.

In alternative embodiments, the secondary memory 1010 may include other similar devices for allowing computer programs or other instructions to be loaded into the computer system 1000. Such devices may include, for example, an interface 1016 and a removable storage unit 1018. Examples of such may include a program cartridge and a cartridge interface (such as that found in video game devices), a removable memory chip (such as an Erasable Programmable Read Only Memory (EPROM), or Programmable Read Only Memory (PROM)) and associated socket, and other removable storage units 1018 and interfaces 1016, which allow software and data to be transferred from the removable storage unit 1018 to the computer system 1000.

The computer system 1000 may include a display interface 1020 that forwards graphics, text, and other data from the communication infrastructure 1004 (or from a frame buffer not shown) for display on the display unit 1022.

The computer system 1000 may also include a communications interface 1024. The communications interface 1024 allows software and data to be transferred between the computer system 1000 and external devices. Examples of the communications interface 1024 may include a modem, a network interface (such as an Ethernet card), a communications port, a Personal Computer Memory Card International Association (PCMCIA) slot and card, etc. Software and data transferred via the communications interface 1024 may be in the form of signals 1026 which may be electronic, electromagnetic, optical, or other signals capable of being received by the communications interface 1024. These signals 1026 are provided to the communications interface 1024 via a communications path (for example, a channel) 1028. This channel 1028 carries signals 1026 and may be implemented using wire or cable, fiber optics, a telephone line, a cellular link, a radio frequency (RF) link and other communications channels.

The computer system 1000 may further include an Input/Output interface 1030 to enable a user to provide input to the computer system 1000. The input may be provided by the user using one or more of a mouse input device and a keyboard input device. As an alternative or in addition to the mouse, the computer system 1000 may include other pointing devices, which include, but are not limited to a trackball, a touch pad and one or more buttons integrated into the keyboard. Those of ordinary skill in the art will appreciate that the same results described herein with reference to a mouse device may be achieved using another available pointing device.

In this document, the terms “computer program medium” and “computer readable medium” are used to generally refer to media such as the removable storage drive 1014, a hard disk installed in the hard disk drive 1010, and signals 1026. These computer program products provide software to computerized information modeling system. The invention is directed to such computer program products.

Computer programs (also referred to as computer control logic) are stored in the main memory 1006 and/or the secondary memory 1008. Computer programs may also be received via the communications interface 1024. Such computer programs, when executed, enable the computer system 1000 to perform the features of the present invention, as discussed herein. In particular, the computer programs, when executed, enable the processor 1002 to perform the features of the present invention. Accordingly, such computer programs represent controllers of the computer system 1000.

In an embodiment where the invention is implemented using software, the software may be stored in a computer program product and loaded into the computer system 1000 using the removable storage drive 1012, the hard drive 1010 or the communications interface 1024. The control logic (software), when executed by the processor 1002, causes the processor 1002 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s). In yet another embodiment, the invention is implemented using a combination of both hardware and software.

The computer system 1000 communicates with the information construct database 102 via the communication interface 1124. The information construct database 102 may be queried using a plurality of query languages, which include, but are not limited to Entity Relationship Role Oriented Language (ERROL), Structured Query Language (SQL) and so on. The information construct database 102 may be managed using a plurality of Database Management System (DBMS) software applications. Examples of such DBMS software applications may include Microsoft SQL SERVER™, ORACLE™ RDBMS, and the like. A person skilled in the art will recognize that the above examples of Query languages and DBMS software applications are only for illustration purpose and many such Query languages and DBMS software applications may be used within the scope and spirit of the invention.

### V. Conclusion

While various embodiments of the present invention have been described above, it should be understood that they have been presented by way of example, and not limitation. It will be apparent to persons skilled in the relevant art(s) that various changes in form and detail may be made therein without departing from the spirit and scope of the present invention. Thus, the present invention should not be limited by any of the above described exemplary embodiments, but should be defined only in accordance with the following claims and their equivalents.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract and Summary sections are not intended to limit the scope of the present invention in any way.

What is claimed is:

1. A method for facilitating discovery and re-use of information constructs, the method comprising:
a. providing an information construct database comprising a plurality of information constructs; and
b. providing an access interface for allowing a user to access the information construct database, wherein the access interface comprises:
i. a discovery interface for allowing the user to discover one or more desired information constructs in the information construct database;
ii. a selection interface for allowing the user to add the one or more desired information constructs to a list of selected information constructs;
iii. an acquisition interface for allowing the user to acquire the information constructs added to the list of selected information constructs in one or more desired formats; and
iv. a publishing interface for allowing the user to publish one or more information constructs in an available format to the information construct database.

2. The method of claim 1, wherein providing the discovery interface comprises:
a. providing a search interface for searching the information construct database for one or more desired information constructs, wherein the searching is based on one or more of:
i. one or more keywords;
ii. one or more community-driven classes assigned to the plurality of information constructs; and
iii. one or more prescriptive taxonomy classes assigned to the plurality of information constructs; and
b. providing a navigation interface for navigating the information construct database based upon at least one of:
i. lineage information of the plurality of information constructs;
ii. one or more community-driven classes assigned to the plurality of information constructs; and
iii. one or more prescriptive taxonomy classes assigned to the plurality of information constructs.

3. The method of claim 1, wherein providing the access interface comprises providing one or more of a web interface and an information modeling environment interface.

4. The method of claim 1, wherein providing the information construct database comprises maintaining metadata information for one or more information constructs, wherein the metadata information for an information construct comprises one or more of:
a. a date of creation of the information construct;
b. a brief description of the information construct;
c. one or more community driven classes assigned to the information construct;
d. one or more prescriptive taxonomy classes assigned to the information construct;
e. lineage information for the information construct;
f. an acquisition count for the information construct; and
g. an acquisition percentage for the information construct.

5. The method of claim 1 further comprising:
a. generating a resource comprising the information constructs in the list of selected information constructs in response to receiving an acquisition instruction from the user through the acquisition interface; and
b. providing the user with one or more of:
i. a Uniform Resource Locator (URL) pointing to the resource;
ii. a downloadable file comprising the resource; and
iii. a drag-and-drop icon for importing at least one information construct in the list of selected information constructs list into an information model.

6. The method of claim 1, wherein the list of selected information constructs is implemented as an online shopping cart.

7. The method of claim 1, further comprising converting the information constructs added to the list of selected information constructs from one or more available formats to one or more desired formats

8. The method of claim 7, wherein the one or more available formats and the one or more desired formats are selected from a group consisting of a Unified Modeling Language (UML) class, a JAVA™ class, an Extensible Markup Language (XML) Schema, an XML Schema Definition (XSD), a relational database entity, and a Unified Modeling Language (UML) class.

9. A system for facilitating discovery and re-use of information constructs comprising:
a. an information construct database; and
b. an access interface allowing a user to access the information construct database, wherein the access interface comprises:
i. a discovery interface for allowing the user to identify one or more desired information constructs in the information construct database;
ii. a selection interface for allowing the user to add the one or more desired information constructs to a list of selected information constructs;
iii. an acquisition interface for allowing the user to acquire the information constructs added to the list of selected information constructs in one or more desired formats; and
iv. a publishing interface for allowing the user to publish one or more information constructs in an available format to the information construct database.

10. The system of claim 9, wherein the discovery interface comprises:
a. a search interface for searching the information construct database for one or more desired information constructs, wherein the searching is based on one or more of:
i. one or more keywords;
ii. one or more community-driven classes assigned to the plurality of information constructs; and
iii. one or more prescriptive taxonomy classes assigned to the plurality of information constructs; and
b. a navigation interface for navigating the information construct database based upon at least one of:
i. lineage information of the plurality of information constructs;
ii. one or more community-driven classes assigned to the plurality of information constructs; and
iii. one or more prescriptive taxonomy classes assigned to the plurality of information constructs.

11. The system of claim 9, wherein the access interface comprises one or more of a web interface and an information modeling environment interface.

12. The system of claim 9, wherein the information construct database maintains metadata information for one or more information constructs, wherein the metadata information for an information construct comprises one or more of:
a. a date of creation of the information construct;
b. a brief description of the information construct;
c. one or more community driven classes assigned to the information construct;
d. one or more prescriptive taxonomy classes assigned to the information construct;
e. lineage information for the information construct;
f. an acquisition count for the information construct; and
g. an acquisition percentage for the information construct.

13. The system of claim 9, further comprising one or more of:
a. a resource generation module for generating a resource comprising the information constructs in the list of selected information constructs in response to receiving an acquisition instruction from the user through the acquisition interface;
b. a link generation module for generating a Uniform Resource Locator (URL) pointing to the resource; and
c. a file generation module for generating a downloadable file comprising the resource.

14. The system of claim 9, wherein the list of selected information constructs is an online shopping cart.

15. A computer program product comprising a computer readable storage medium having control logic stored therein for causing a computer to facilitate discovery and re-use of information constructs, the control logic comprising:
a. first computer readable program code that causes the computer to provide an information construct database comprising a plurality of information constructs;
b. second computer readable program code that causes the computer to provide an access interface allowing a user to access the information construct database, wherein the access interface comprises:
v. a discovery interface for allowing the user to identify one or more desired information constructs in the information construct database;
vi. a selection interface for allowing the user to add the one or more desired information constructs to a list of selected information constructs;
vii. an acquisition interface for allowing the user to acquire the information constructs added to the list of selected information constructs in one or more desired formats; and
viii. a publishing interface for allowing the user to publish one or more information constructs in an available format to the information construct database.

16. The computer program product of claim 15, wherein the second computer readable program code further comprises:
a. third computer readable program code that causes the computer to provide a search interface for searching the information construct database for one or more desired information constructs, wherein the searching is based on one or more of:
iv. one or more keywords;
v. one or more community-driven classes assigned to the plurality of information constructs; and
vi. one or more prescriptive taxonomy classes assigned to the plurality of information constructs; and
b. fourth computer readable program code that causes the computer to provide a navigation interface for navigating the information construct database based upon at least one of:
iv. lineage information of the plurality of information constructs;
v. one or more community-driven classes assigned to the plurality of information constructs; and
vi. one or more prescriptive taxonomy classes assigned to the plurality of information constructs.

17. The computer program product of claim 15, wherein the second computer readable program code further comprises one or more of: fifth computer readable program code that causes the computer to provide a web interface; and sixth computer readable program code that causes the computer to provide an information modeling environment interface.

18. The computer program product of claim 15, wherein the first computer readable program code further comprises: seventh computer readable program code that causes the computer to maintain metadata information for one or more information constructs, wherein the metadata information for an information construct comprises one or more of:
a. a date of creation of the information construct;
b. a brief description of the information construct;
c. one or more community driven classes assigned to the information construct;
d. one or more prescriptive taxonomy classes assigned to the information construct;
e. lineage information for the information construct;
f. an acquisition count for the information construct; and
g. an acquisition percentage for the information construct.

19. The computer program product of claim 15, wherein the second computer readable program code further comprises:
a. eighth computer readable program code that causes the computer to generate a resource comprising the information constructs in the list of selected information constructs in response to receiving an acquisition instruction from the user through the acquisition interface; and
b. ninth computer readable program code that causes the computer to providing the user with one or more of:
1. a Uniform Resource Locator (URL) pointing to the resource;
2. a downloadable file comprising the resource; and
3. a drag-and-drop icon for importing at least one information construct in the list of selected information constructs list into an information model.

20. A tangible computer-readable medium having stored thereon, computer-executable instructions that, if executed by a computing device, cause the computing device to perform a method comprising:
allowing a user to discover one or more desired information constructs in an information construct database using a discovery interface;
allowing the user to add the one or more desired information constructs to a list of selected information constructs using a selection interface;
allowing the user to acquire the information constructs added to the list of selected information constructs in one or more desired formats using an acquisition interface; and
allowing the user to publish one or more information constructs in an available format to the information construct database using a publishing interface.
